(19) United States
(12) Patent Application Publication
(10) Pub. No.: US 2007/0291986 A1
(43) Pub. Date: Dec. 20, 2007

(54) Method, medium, and system generating navigation information of input video

(75) Inventors: Jin Guk Jeong, Yongin-si (KR); Cheol Kon Jung, Suwon-si (KR); Ji Yeun Kim, Seoul (KR); Young Su Moon, Yangcheon-gu (KR); Sang Kyun Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/641,024

(22) Filed: Dec. 19, 2006

(30) Foreign Application Priority Data
Jun. 15, 2006 (KR) 10-2006-0053878

(51) Int. Cl. G06K 9/00

(52) U.S. Cl. 382/103

(57) ABSTRACT

A method, medium, and system generating navigation information of a sports video. The method may include detecting a candidate navigation point by analyzing video data in the sports video, and analyzing a caption from the candidate navigation point and generating the navigation information by determining a navigation section according to a result of the caption analysis.

### CROSS-REFERENCE TO RELATED APPLICATIONS

This application claims priority from Korean Patent Application No. 10-2006-0053878, filed on Jun. 15, 2006, in the Korean Intellectual Property Office, the entire disclosure of which is incorporated herein by reference.

### BACKGROUND OF THE INVENTION

1. Field of the Invention

An embodiment of the present invention relates at least to a method, medium, and system rapidly generating navigation information of a sports video by detecting candidate navigation points in the sports video and recognizing captions at the points.

2. Description of the Related Art

In recent days, advanced video players have been used to generate high-speed navigation information of reproduced video data to enable a user to easily locate desired video portions or streams, or portions within streams, from reproduced and available video streams.

Additionally, advanced portable players for video-on-demand (VOD) services generate navigation maps in a network to effectively service particular desired parts from among an entire stream or a desired stream from available streams.

Here, in the case of sports videos, such navigation maps are based on time units familiar to a user, for example, the time units might correspond to the top and bottom of innings in a baseball game, serve games in tennis, sets in volleyball, and the like.

One example of conventional techniques for such video navigation, using low-level information, has been discussed in U.S. Pat. No. 5,708,767, entitled “Method and apparatus for video browsing based on content and structure”. Here, a variation in scenes is detected based on color histograms and edge information, to cluster similar scenes based on average color histograms of each scene, and extract representative frames by selecting a mean (e.g., average) frame among a group of similar scenes.

Another example of a conventional technique for video navigation, using low-level information, has similarly been discussed in the U.S. Pat. No. 5,664,227, entitled “System and method for skimming digital audio/video data”. Here, shot variations are detected and then a representative frame of each shot is selected so that a user can see a desired shot by selecting a relevant representative frame. Here, the term shot can be representative of a series of temporally related frames for a particular play or frames that have a common feature or substantive topic, for example. For example, types of baseball shots may include events such as strike-outs, home runs, or some apparent exciting series of frames. In this conventional technique, other representative frames with similar properties are also found as the selected representative frame, and a group of similar representative frames are shown to a user.

Since these conventional methods for a video navigation use low-level information, such as color and motion, it may be difficult to generate the aforementioned navigation information that is more familiar to a user.

Conversely, another conventional technique for a video navigation, using high-level information, has been discussed in the U.S. patent application Publication No. 2002/0126143, entitled “Article-based news video content summarizing method and browsing system”. Here, this conventional technique discusses navigating news shows/streams based on article units, extracting texts from news articles, and generating a synthetic key frame of each article by using the extracted texts, with the synthetic potentially including a merging of the extracted texts into one frame.

Another example of such a conventional technique for a video navigation using high-level information has been discussed in Korean Patent Application Publication No. 2001-0028735, entitled “Method for composing abstract/detail relationships information between segments of multimedia stream and video browsing method thereof”. Here, there is a defining of an abstract/detail relationship between segments, event blocks, scenes, or shots in different streams, and browsing for fully displaying only desired portions by using information on the abstract/detail relationship.

These conventional techniques for video navigation using high-level information have mostly been applied to navigation for news articles, and not applied to sport navigation.

Lastly, one further example of a conventional technique for a video navigation using high-level information has been proposed in the paper entitled “Event detection in baseball video using superimposed caption recognition,” presented at the tenth ACM international conference on Multimedia (ACM MM 2002). This discussion explains detecting/recognizing text to detect events such as scoring, detecting event boundaries by using detections of pitch view and non-active view, and using temporal sample frames for event detections.

However, as discussed above, such video-navigating techniques, using high-level information, may require more time and/or processing power for text detection/recognition. Accordingly, when such works are executed in all video portions and/or streams, an unfavorable drop in speed is typically required for the generating of the navigation information.

Accordingly, the present inventors have determined that there is a desire for the resolution of the above problems and drawbacks.

### SUMMARY OF THE INVENTION

An aspect of an embodiment of the present invention is to provide a method, medium, and system generating navigation information, which reduce the required number of frames required for the caption detection/recognition and improve detection speeds by previously detecting a candidate navigation point through a detection of a play scene in the sports video.

Another aspect of an embodiment of the present invention is to provide a method, medium, and system generating navigation information to enable a user to easily locate a desired scene in a sports video, by offering a time unit familiar to the user as the navigation information.

Still another aspect of an embodiment of the present invention is to provide a method, medium, and system generating navigation information to allow high-speed indexing and navigation by effectively performing a play scene detection and caption recognition in a sports video.

Additional aspects and/or advantages of the invention will be set forth in part in the description which follows and, in part, will be apparent from the description, or may be learned by practice of the invention.

To achieve the above and/or other aspects and advantages, an embodiment of the present invention includes a method for generating navigation information of a sports video, including detecting a candidate navigation point of video data of the sports video, and analyzing a caption in the video data based on the candidate navigation point and generating final navigation information by determining a navigation section, for the final navigation information, based on the caption analysis.

The detecting of the candidate navigation point may include detecting a play scene in the video data, and detecting the candidate navigation point based on the detected play scene.

Here, the detecting of the candidate navigation point may further include comparing a current play scene with a former play scene to obtain a corresponding difference, and detecting the current play scene as the candidate navigation point when the difference meets a given condition.

The difference may be based upon a distance between at least one modeling cluster corresponding to the former play scene and a modeling cluster representative of the current play scene.

Further, the detecting of the play scene may include using a detecting of a pitching scene as a play start point when the video data is related to baseball.

Still further, the detecting of the play scene may include using a detecting a serve scene as a play start point when the video data is related to tennis or volleyball.

Further, the detecting of the play scene may include using a detecting of scenes of the video data not representing a close-up scene for detection of a play start scene when the video data is related to soccer.

In addition, the analyzing of the caption may include detecting the caption at the candidate navigation point and recognizing a significant caption in the detected caption, and generating the final navigation information by designating the navigation section according to the recognized significant caption.

Here, the detecting of the caption and the recognizing of the significant caption may include detecting a caption region by selecting a play start point as an input frame at the candidate navigation point, and detecting a candidate significant caption in the detected caption region and recognizing the significant caption by a variation and a pattern of a text part in the candidate significant caption.

The generating of the final navigation information may further include generating the final navigation information by designating, as a corresponding navigation starting point, a point where a time unit is changed from a previous indication in the recognized significant caption in the navigation section.

To achieve the above and/or other aspects and advantages, an embodiment of the present invention may include at least one medium including computer readable code to control at least one processing element to implement an embodiment of the present invention.

To achieve the above and/or other aspects and advantages, an embodiment of the present invention includes a system generating navigation information of a sports video, including a play scene detecting unit to detect a play scene in video data of the sports video, a candidate navigation point detecting unit to detect a candidate navigation point based on the play scene, a caption recognizing unit to recognize a significant caption in the video data based on the candidate navigation point, and a navigation information generating unit to generate final navigation information by determining a navigation section, for the final navigation information, based on the significant caption.

The candidate navigation point detecting unit may compare a current play scene with a former play scene to obtain a corresponding difference, and detect the current play scene as the candidate navigation point when the difference meets a given condition.

Here, the difference may be based upon a distance between at least one modeling cluster corresponding to the former play scene and a modeling cluster representative of the current play scene.

Further, the caption recognizing unit may select a play start point in a time window as an input frame from the candidate navigation point, detects a caption region in the selected input frame, determine a candidate significant caption region by checking a position of the caption region or a repeatability of a color pattern, and recognize the significant caption by examining a variation and a pattern of a text part in the candidate significant caption region.

Here, the navigation information generating unit may generate the final navigation information by determining, as a navigation starting point, a point where a time unit is changed from a previous indication in the recognized significant caption in the navigation section.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a method for generating navigation information of a sports video, according to an embodiment of the present invention;

FIG. 2 illustrates examples of play scenes, according to an embodiment of the present invention;

FIG. 3 illustrates a method of detecting a play start point, according to an embodiment of the present invention;

FIG. 4 illustrates a method of learning an online model, according to an embodiment of the present invention;

FIG. 5 illustrates a method of detecting a close-up scene, according to an embodiment of the present invention;

FIG. 6 illustrates a shifting of a spatial window, according to an embodiment of the present invention;

FIG. 7 illustrates candidate navigation points in a baseball game video, according to an embodiment of the present invention;

FIG. 8 illustrates a method of detecting candidate navigation points, according to an embodiment of the present invention;

FIG. 9 illustrates an input frame for detecting a significant caption, according to an embodiment of the present invention;

FIG. 10 illustrates a method of recognizing a significant caption, according to an embodiment of the present invention; and

FIG. 11 illustrates a system generating navigation information of a sports video, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

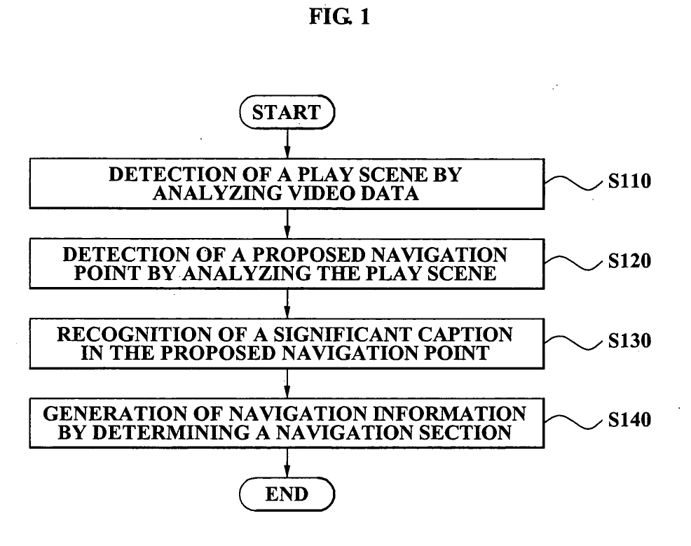

FIG. 1 illustrates a method for generating navigation information of a sports video, according to an embodiment of the present invention.

Referring to FIG. 1, in operation S110, a play scene may be detected by analyzing video data in a sports video, for example. As a further example, the play scene may include play start points in video streams of particular game types, such as baseball, tennis, and volleyball, the sports videos that involve discontinuous play. Similarly, in other game types, such as soccer, the video stream may involve continuous play, and the play scene may include scenes for most of the game except for temporary cessations of play, e.g., such as that caused by a halftime period or referee's time-out for foul deliberations.

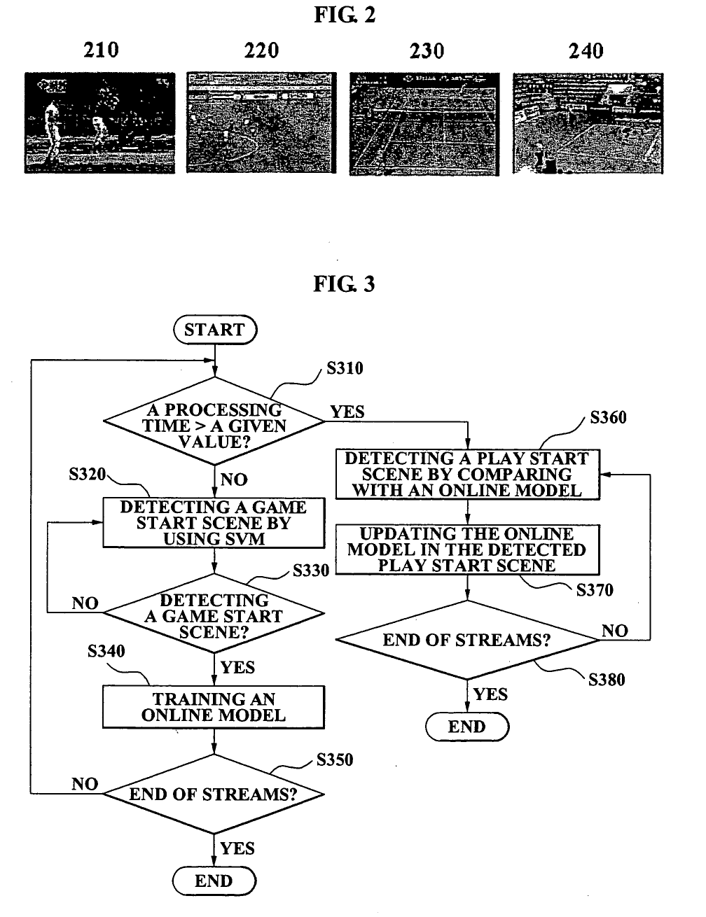

Here, as only an example, FIG. 2 illustrates a few of such play scenes.

Referring to FIG. 2, the frame 210 represents a pitching scene of a pitcher, as a play start point in a baseball video stream, while frame 220 represents a wide view scene, i.e., not a close-up scene, in a play scene in a soccer video stream. Similarly, frames 230 and 240 represent serve scenes as play start points in tennis and volleyball video streams, respectively.

FIG. 3 illustrates a method of detecting a play start point, according to an embodiment of the present invention.

Referring to FIG. 3, in operation S310, it may be determined whether a processing time of a sports video stream is greater than a given value.

If the processing time is not greater than the given value, a play start scene from broadcasting data of the sports video stream may be detected, in operation S320, e.g., by using a particular pre-existing model, such as a model that has previously been established by a support vector machine (SVM). Here, as an example, edge distribution may be implemented in such an SVM modeling.

Next, in operation S330, it may be determined whether the play start scene is detected, e.g., by way of the SVM model.

If the play start scene is detected, next, in operation S340, an online model may be employed by using the detected play start scene. Here, a reference to online, and potentially, offline training models refers to models that operate in real-time with received video data and models that operate after receipt of the video data, respectively. Such real-time operation may further include dynamic changes to the model while operating in real-time. Further, regarding such modeling, where learning is involved, such learning may be implemented through clustering of data. Clustering is a technique of grouping similar or related items or points based on that similarity, e.g., the online model may have several clusters for differing respective potential events. One cluster may include separate data items representative of separate respective frames that have attributes that could categorize the corresponding frame with one of several different potential events, such as a pitching scene or a home-run scene, for example. A second cluster could include separate data items representative of separate respective frames for an event other than the first cluster. Potentially, depending on the clustering methodology, some data items representative of separate respective frames, for example, could even be classified into separate clusters if the data is representative of the corresponding events. In addition, here, any use of the term “key frame” is a reference to an image frame or merged data from multiple frames that may be extracted from a video sequence to generally express the content of a unit segment, i.e., a frame capable of best reflecting the substance within that unit segment/shot, and potentially, in some examples, may be a first scene of the corresponding play encompassed by the unit segment, such as a pitching scene.

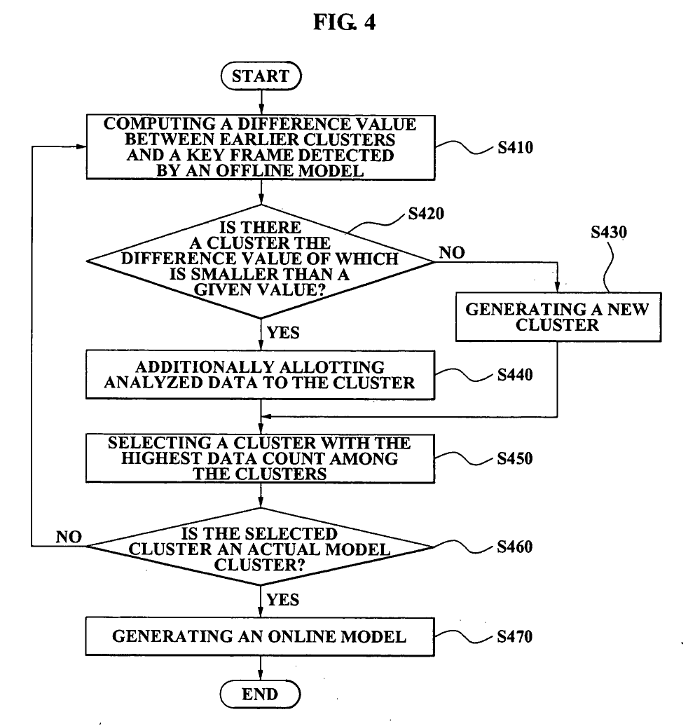

Accordingly, FIG. 4 illustrates such a method of teaching an online model, for example, according to an embodiment of the present invention.

Referring to FIG. 4, in operation S410, based on previous calculated/identified clusters, e.g., of units of data, a difference value between current data and previous designated clusters may be compared, e.g., using a key frame detected by way of an offline model that may have already been established by an SVM offline model, for example. Alternatively, a difference value between current data and previously designated clusters may be calculated based on a Euclidean distance of a Hue, Saturation, and Value (HSV) histogram, for example.

Next, in operation S420, it may be determined whether one of at least one previously designated cluster(s) is within a computed difference value, e.g., a given value, of the current data, e.g., data units in units of frames or pixels. In other words, it can be determined whether there exists a cluster to which the analyzed data should be allotted, based on the calculated difference value, i.e., for further learning/teaching of the online model. Here, the more data provided to differing clusters of the online model, the more accurate each cluster may be for identifying the underlying feature that cluster is supposed to identify in a minimum, whether the minimum unit is a frame or pixel, for example. In addition, here, according to an embodiment of the present invention, if the difference value for analyzed data is sufficiently low for more than one cluster, the data may be added to more than one cluster.

Further, if there is no cluster within a distance (the difference value) smaller than the given value, in operation S430, a new cluster(s) may be generated by using the analyzed data, in operation S440. Specifically, when the analyzed data is substantially different from the previously analyzed data, and there is no exciting data (or event data) similar to the previously analyzed data, the new cluster(s) may be generated with the analyzed data.

Next, in operation S450, available clusters that, thus, may actually be used with an implemented model may be selected from among the now available clusters. Specifically, for example, clusters that include the most data may be selected for use in such an implemented model.

Subsequently, in operation S460, it may be determined whether the selected cluster corresponds to the cluster for the to be implemented model, such as through a repeatable test operation. Conditions of the above determination, thus, may depend upon the actual model that will be implemented. For example, when the actual model to be implemented is a field color model, a maximum range of the field color may be used to determine whether the cluster corresponds to a cluster for the model to be implemented. In another case, when the actual model to be implemented is a pitching scene, for example, it may be determined, e.g., using repeatability, whether the frame has been repeated over a short period of time.

In this example, when the above-discussed online model is a pitching scene key frame model, and the data count included in the selected cluster is greater than the given value, it may be determined that the corresponding cluster of a pitching scene key frame online model exists.

In another case, where the online model is a ground color model, and the processing time of the stream is greater than the given value, it may be determined that the corresponding cluster of a ground color online model exists.

Similarly, if the selected cluster is determined to correspond to the model that is to be implemented, in operation S470, a corresponding online model may be generated by using data existing in the selected cluster. In another example, the above online model may be formed by way of an edge distribution and a HSV histogram, for example.

Since the data existing in the cluster are homogeneous, in general, the online model may be generated by using, as a model, a representative value, an average value, or a median value of features extracted from these homogeneous data, for example.

Further, when the online model is a pitching scene key frame model, the online model may be generated by using average values of the edge distribution and the HSV histogram used for clustering.

In yet another example, where the online model is a ground color model, the online model may be generated by using an average value of the HSV histogram in a model cluster.

As discussed heretofore, according to an embodiment of the present invention, a method for generating navigation information may include generating a more suitable online model by analyzing data to detect a play start points in the sports video.

Additionally, the navigation information generating method, according to an embodiment of the present invention, may shorten a clustering execution time by immediately executing a clustering as soon as a single datum is entered through the online model learning procedure, for example.

Returning to FIG. 3, in operation S350, it may be determined whether a current stream, e.g., of a sports video, passing through the online model training, is indicated as being the end of the streams of the sports video.

If the current stream is not indicated as being the end of the streams, the operation S310 may be repeated.

Conversely, if the processing time is greater than a given value, as the result of the decision in operation S310, a play start scene may be detected, in operation S360, by computing a difference of the broadcasting data of the sports video stream in comparison with the online model. In this instance, a difference value may be calculated between the online model and the sports video stream by using an edge distribution and a weighted Euclidean distance of the HSV histogram, for example.

Here, when the sports video is related to baseball, the play start scene may be detected by comparing the broadcasting data of the sports video with a corresponding online model, e.g., the pitching scene, such as that represented by the frame 210 shown in FIG. 2.

Similarly, where the sports video is related to tennis or volleyball, the play start scene may be detected by comparing the broadcasting data of the sports video with a corresponding online model, e.g., serve scenes, such as those represented respectively by frames 230 and 240 shown in FIG. 2.

When a play start scene is detected, next, in operation S370, the online model may be updated by computing an average value of features in the detected play start scene, for example.

Subsequently, in operation S380, it may be determined whether the current stream indicates that it is the end of the streams of the sports video.

If the current stream is not the end of the streams, operation S360 may be repeated because the above-discussed update for the online model may not be executed until the end of the sports video streams, according to one embodiment of the present invention.

If the current stream indicates that it is the end of the streams, e.g., as a result of the decision in operation S350 or operation S380, the detection of the play start points may be terminated.

A navigation information generating method, according to an embodiment of the present invention, may initially detect a play scene by using a model pre-established by the SVM and then, after the online model in which features of each stream have been reflected is generated, the play scene may be detected by using the online model.

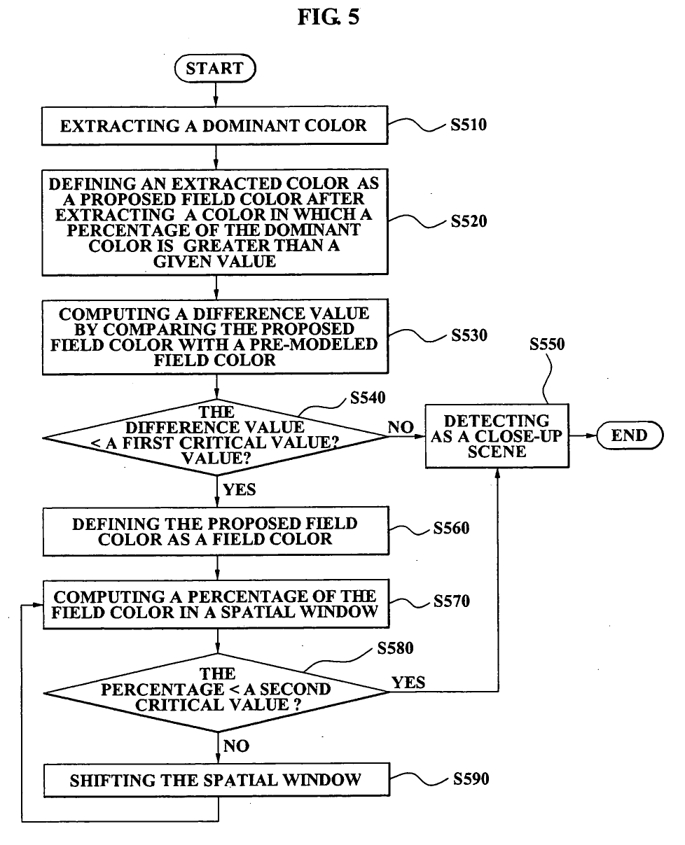

FIG. 5 illustrates a method of detecting a close-up scene, according to an embodiment of the present invention.

Referring to FIG. 5, in operation S510, a dominant color may be extracted from a scene of the sports video.

Next, in operation S520, the color in which a percentage of the dominant color is greater than a given value may be extracted, and then the extracted color may be defined as a candidate field color.

Subsequently, in operation S530, a difference value may be computed by comparing the candidate field color with a pre-modeled field color.

Next, in operation S540, it may be decided whether the difference value is smaller than a first critical value, for example.

If the difference value is not smaller than the first critical value, the corresponding scene of the sports video may be designated to be a close-up scene, in operation S550. In a general scene, the field color may be the dominant color of the sports video scene. However, in the close-up scene, some colors, such as a color of the player's uniform, other than the field color may become the dominant color. Therefore, if the difference value is greater than the first critical value, the corresponding scene may be determined to be a close-up scene since the dominant color is not the field color.

If the difference value is smaller than the first critical value, the candidate field color may be designated to correspond to the field color, in operation S560.

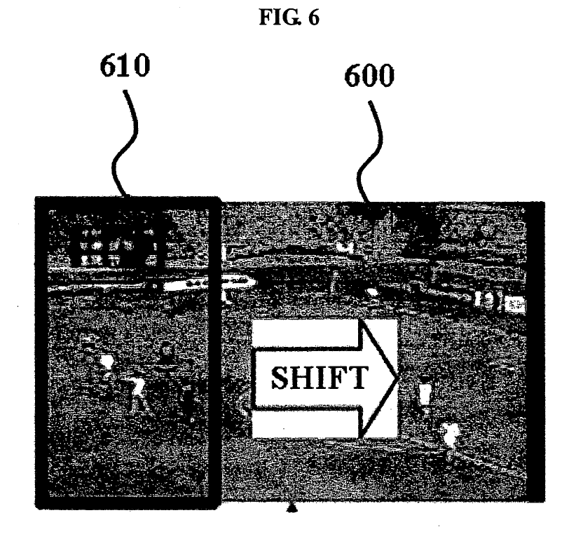

Next, in operation S570, a percentage of the field color in a spatial window 610 of the sports video 600, as shown in FIG. 6, may be computed.

Further, in operation S580, it may be determined whether the computed percentage of the field color is smaller than a second critical value.

If the percentage of the field color is smaller than the second critical value, the corresponding scene of the sports video may be determined to be a close-up scene, as in the above-discussed operation S550.

If the percentage of the field color is not smaller than the second critical value, the spatial window 610 of the sports video 600 may be shifted, in operation 590, as shown in FIG. 6. After the shift of the spatial window 610, operation S570 may be repeated.

Further to the above, when the sports video is related to soccer, for example, and the close-up scene is detected, the other scenes, excluding the close-up scene, may be designated as the play scenes.

Briefly, returning again to FIG. 1, it was noted that in operation S120 candidate navigation points may be detected by analyzing the detected play scenes.

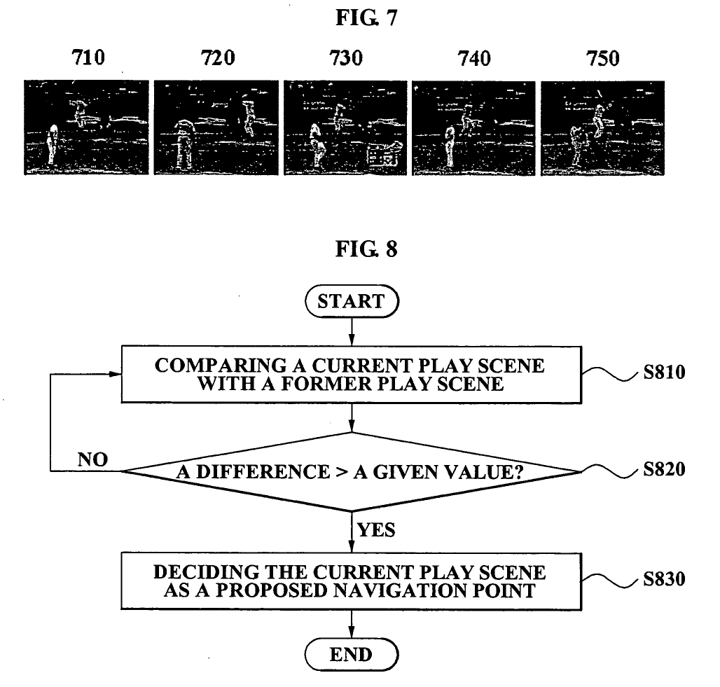

Accordingly, FIG. 7 illustrates candidate navigation points in baseball, according to an embodiment of the present invention, noting that alternate embodiments are equally available.

Referring to FIG. 7, as only an example, frames 710 and 720 represent the top and bottom of a 6^{th} inning, respectively. Similarly, frames 730 and 750 represent the top and a bottom of a 7^{th} inning, respectively. In addition, frame 740 represents the case where a relief pitcher is brought in. As shown in FIG. 7, candidate navigation points in such baseball scenes may be the top and bottom of innings or the point when the relief pitcher is brought in.

FIG. 8 illustrates a method of detecting such candidate navigation points, according to an embodiment of the present invention.

Referring to FIG. 8, in operation S810, a current play scene may be compared with a former play scene to obtain a difference therebetween.

Next, in operation S820, it may be decided whether the above difference is greater than a given value.

If the difference is greater than the given value, it may be decided, in operation S830, that the current play scene should be a candidate navigation point.

As discussed above, such a navigation information generating method, according to an embodiment of the present invention, may detect candidate navigation points by using a gap between the play start points. A large gap between the play start points in the sports video may indicate that a temporarily cessation of play has been relatively long. With above the time units, such as top/bottom of innings in a baseball stream, additional time units may also include serve games of tennis, and sets of volleyball, where the temporary cessation of play may be caused by the insertion of the relief pitcher, an injury of a player, a time-out, and the like, noting that alternative embodiments are equally available.

Briefly, returning to FIG. 1, it was noted that in operation S130 captions may be detected at candidate navigation points, and significant captions may be recognized in the detected captions. Such a significant caption may include a subtitle representing each time unit, such as top/bottom of innings in baseball, serve games of tennis, and sets of volleyball, for example. Since the sports video may have many captions, in addition to the significant caption, such as advertisements, the significant captions may be recognized from among the detected captions.

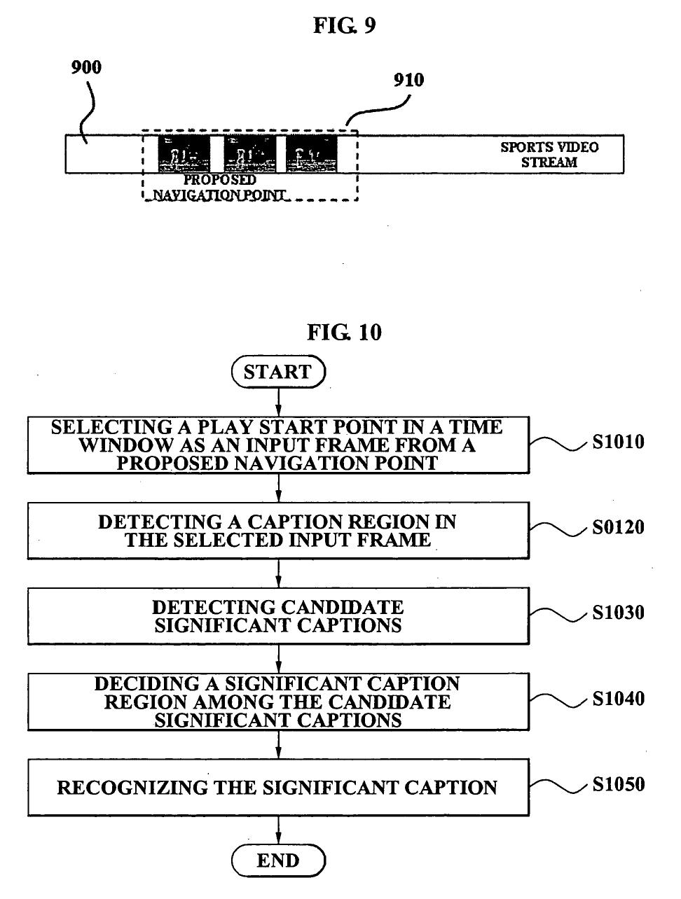

Accordingly, FIG. 9 illustrates an input frame for detecting a significant caption, according to an embodiment of the present invention, noting that alternative examples are equally available.

Starting from the candidate navigation point in a sport video stream 900, there may be a selection, as an input frame, of the play start point existing in a time window 910.

FIG. 10 illustrates a method of recognizing a significant caption, according to an embodiment of the present invention.

Referring to FIG. 10, in operation S1010, a play start point may be selected in a time window as an input frame, starting from a candidate navigation point.

Detection of caption regions from the entire sports video stream may give rise to highly complex calculations. Thus, in a navigation information generating method, according to an embodiment of the present invention, the play start point and the candidate navigation point may be detected, and then the play start point only existing in the time window from the candidate navigation point may be selected as the input frame. By imposing restrictions on the number of the input frames as the above, such a method can, thus, improve detection speeds.

Next, in operation S1020, the caption region may be detected in the selected input frame.

Subsequently, in operation S1030, candidate significant captions with the greatest potential of being a significant caption may be detected by checking the position of the caption region and/or the repeatability of a color pattern, for example.

Next, in operation S1040, a significant caption region may be determined from among the candidate significant captions. For example, when the video is of baseball, a significant caption region may include inning information, strike/ball count information, and out count information in a text portion area, for example. Alternate embodiments may equally be available.

In operation S1050, the significant caption may be recognized by examining variations and patterns of text portions in the significant caption region. For example, in the case of a baseball video, the strike/ball/out count information may vary accordingly as the game progresses, but the inning information does not vary until the inning itself is finished. Therefore, the inning information may be recognized as the significant caption by checking the variations and patterns of the text portions. Furthermore, when the strike/ball/out count information are zero, that occasion may be recognized as the start of the inning.

As discussed above, according to an embodiment of the present invention, a navigation information generating method may select, as the input frame, a play start point existing in a time window from a candidate navigation point, and then, by detecting/recognizing a significant caption from the selected input frame, output information about the current time unit.

Again, briefly, returning to FIG. 1, it was noted that in operation S140 that a navigation section may be determined according to the recognized significant caption, and navigation information may be generated therefrom. Specifically, a point where the time unit has changed may be determined to be a navigation starting point based on the recognized significant caption in the navigation section, and then the navigation information may be generated.

Here, when the sports video is related to baseball, in operation S140, a change of the top/bottom of the inning may be recognized from the inning information and the out count information, and the recognized point may be determined to be the navigation starting point.

In another case, where the sports video is related to tennis, in operation S140, a change of the serve game from a score reset and information about an index of each serve game may be recognized, and the recognized point may be determined to be the navigation starting point.

Further, in the case where the sports video is related to volleyball, in operation S140, a change of the set may be recognized from score information and set index information, and the recognized point may be determined as the navigation starting point.

Accordingly, as discussed above, according to an embodiment of the present invention, a navigation information generating method may provide navigation information with time units, such as the top and bottom of innings in baseball, serve games in tennis, and sets in volleyball, which are familiar to a user. Accordingly, such a method may enable a user to easily locate a desired scene in the sports video.

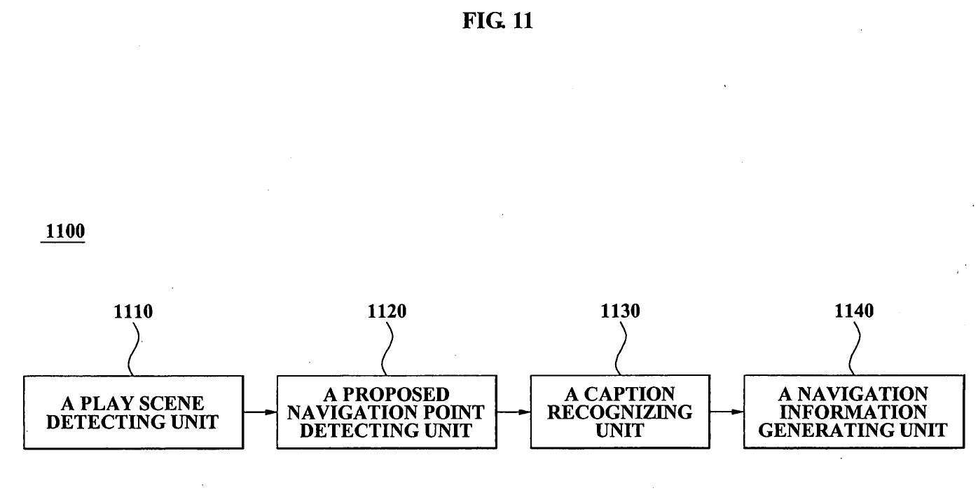

FIG. 11 illustrates a system generating navigation information, e.g., of a sports video, according to an embodiment of the present invention.

Referring to FIG. 11, the navigation information generating system 1100 may include a play scene detecting unit 1110, a candidate navigation point detecting unit 1120, a caption recognizing unit 1130, and a navigation information generating unit 1140, for example.

The play scene detecting unit 1110 may detect a play scene by analyzing video data in a sports video. Specifically, when the sports video represents as sport such as baseball, tennis, and volleyball, the play scene detecting unit 1110 may detect the play start point as the play scene. In another case where the sports video represents a sport such as soccer, the play scene detecting unit 1110 may detect, as the play scene, a certain scene from most occasions other than scenes during temporary cessations of play, such as that caused by a halftime or a delay caused by a referee's decision.

The candidate navigation point detecting unit 1120 may detect the candidate navigation point. Specifically, the candidate navigation point detecting unit 1120 may analyze the detected play scene and then detect the candidate navigation point by using a gap between the play start points. In addition to the time units such as top and bottom of innings in baseball, serve games of tennis, and sets of volleyball, the candidate navigation point may include the cessation time caused by entry of a relief pitcher, an injury of a player, a time-out for consultation, and the like. Accordingly, the candidate navigation point detecting unit 1120 may compare the current play scene with a former play scene to obtain a difference therebetween, e.g., by analyzing the play scene, and detect the current play scene as the candidate navigation point when, as the result of the comparison, the difference is greater than a given value.

The caption recognizing unit 1130 may recognize the significant caption by analyzing the candidate navigation point. That is, the caption recognizing unit 1130 may select, as the input frame, the play start point only existing in the time window from the candidate navigation point, and detect the caption region in the selected input frame. Furthermore, the caption recognizing unit 1130 may detect the candidate significant caption region by checking the position of the caption region or the repeatability of a color pattern, and recognize the significant caption by examining a variation and a pattern of the text part in the significant caption region, for example.

The navigation information generating unit 1140 may determine the navigation section according to the recognized significant caption, for example, and generate the navigation information therefrom. Specifically, the navigation information generating unit 1140 may determine, as the navigation starting point, a point where the time unit is changed by the recognized significant caption in the navigation section, and then generate the navigation information.

Accordingly, the system 1100 generating navigation information, according to an embodiment of the present invention, previously detects candidate navigation points through the detection of the play scene, and then executes the detection/recognition of the caption at the candidate navigation point. Therefore, such a system may reduce the number of frames required for the caption detection and recognition, and thus improve the detection speed.

Additionally, in one embodiment, the system 1100 may further allow for the effective transaction of the play scene detection and the caption detection/recognition, and thus offer a real-time navigation in a variety of embedded devices.

Furthermore, in one embodiment, the system 1100 may provide the navigation information with a time unit, such as top/bottom of innings in baseball, serve games in tennis, and sets in volleyball, familiar to a user. Accordingly, a user may be able to easily locate a desired scene in the sports video based upon familiar time units.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

As discussed hereinbefore, an embodiment of the present invention includes a method, medium, and system that may reduce the number of frames needed for the caption detection/recognition and improve the detection speed by previously detecting a candidate navigation point through a detection of a play scene in the sports video.

Additionally, an embodiment of the present invention includes a method, medium, and system that may enable a user to easily locate a desired scene in a sports video by offering the user a time unit familiar to a user as the navigation information.

Furthermore, an embodiment of the present invention includes method, medium, and system that may allow high-speed indexing and navigation by effectively performing operations of a play scene detection and caption recognition in a sports video.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method for generating navigation information of a sports video, comprising:
detecting a candidate navigation point of video data of the sports video; and
analyzing a caption in the video data based on the candidate navigation point and generating final navigation information by determining a navigation section, for the final navigation information, based on the caption analysis.

2. The method of claim 1, wherein the detecting of the candidate navigation point comprises:
detecting a play scene in the video data; and
detecting the candidate navigation point based on the detected play scene.

3. The method of claim 2, wherein the detecting of the candidate navigation point further comprises:
comparing a current play scene with a former play scene to obtain a corresponding difference; and
detecting the current play scene as the candidate navigation point when the difference meets a given condition.

4. The method of claim 3, wherein the difference is based upon a distance between at least one modeling cluster corresponding to the former play scene and a modeling cluster representative of the current play scene.

5. The method of claim 2, wherein the detecting of the play scene comprises:
using a detecting of a pitching scene as a play start point when the video data is related to baseball.

6. The method of claim 2, wherein the detecting of the play scene comprises:
using a detecting a serve scene as a play start point when the video data is related to tennis or volleyball.

7. The method of claim 2, wherein the detecting of the play scene comprises:
using a detecting of scenes of the video data not representing a close-up scene for detection of a play start scene when the video data is related to soccer.

8. The method of claim 1, wherein the analyzing of the caption comprises:
detecting the caption at the candidate navigation point and recognizing a significant caption in the detected caption; and
generating the final navigation information by designating the navigation section according to the recognized significant caption.

9. The method of claim 8, wherein the detecting of the caption and the recognizing of the significant caption comprises:
detecting a caption region by selecting a play start point as an input frame at the candidate navigation point; and
detecting a candidate significant caption in the detected caption region and recognizing the significant caption by a variation and a pattern of a text part in the candidate significant caption.

10. The method of claim 8, wherein the generating of the final navigation information comprises:
generating the final navigation information by designating, as a corresponding navigation starting point, a point where a time unit is changed from a previous indication in the recognized significant caption in the navigation section.

11. At least one medium comprising computer readable code to control at least one processing element to implement the method of claim 1.

12. A system generating navigation information of a sports video, comprising:
a play scene detecting unit to detect a play scene in video data of the sports video;
a candidate navigation point detecting unit to detect a candidate navigation point based on the play scene;
a caption recognizing unit to recognize a significant caption in the video data based on the candidate navigation point; and
a navigation information generating unit to generate final navigation information by determining a navigation section, for the final navigation information, based on the significant caption.

13. The system of claim 12, wherein the candidate navigation point detecting unit compares a current play scene with a former play scene to obtain a corresponding difference, and detects the current play scene as the candidate navigation point when the difference meets a given condition.

14. The system of claim 13, wherein the difference is based upon a distance between at least one modeling cluster corresponding to the former play scene and a modeling cluster representative of the current play scene.

15. The system of claim 12, wherein the caption recognizing unit selects a play start point in a time window as an input frame from the candidate navigation point, detects a caption region in the selected input frame, determines a candidate significant caption region by checking a position of the caption region or a repeatability of a color pattern, and recognizes the significant caption by examining a variation and a pattern of a text part in the candidate significant caption region.

16. The system of claim 15, wherein the navigation information generating unit generates the final navigation information by determining, as a navigation starting point, a point where a time unit is changed from a previous indication in the recognized significant caption in the navigation section.
